(19) United States
(12) Patent Application Publication
(10) Pub. No.: US 2026/0086767 A1
(43) Pub. Date: Mar. 26, 2026

(54) FLEXIBLE USER INTERFACE FOR MULTI-ZONE DEVICE

(71) Applicant: Sonos, Inc., Goleta, CA (US)

(72) Inventors: Defne Civelekoglu, Goleta, CA (US); EJ Fitzpatrick, Goleta, CA (US); Mark Belding, Goleta, CA (US); Jake Chervin, Goleta, CA (US); Lyford Beverage, Goleta, CA (US)

(21) Appl. No.: 19/339,828

(22) Filed: Sep. 25, 2025

Related U.S. Application Data
(60) Provisional application No. 63/699,413, filed on Sep. 26, 2024.

(51) Int. Cl. G06F 3/16

(52) U.S. Cl. CPC G06F 3/165; G06F 3/167

(57) ABSTRACT

A flexible user interface for a multi-zone device is described. The flexible user interface comprises a set of regions corresponding to a set of outputs of the multi-zone device. The appearance of one or more regions in the set of regions is updated with one or more visual indications based on data corresponding to the playback zone configuration of the multi-zone device, so that the user interface reflects the playback zone configuration.

### CROSS REFERENCE TO RELATED APPLICATIONS

This application claims priority to U.S. Provisional App. 63/699,413 titled “Flexible User Interface for Multi-Zone device,” filed on Sep. 26, 2024, and currently pending. The entire contents of U.S. Provisional App. 63/699,413 is incorporated by reference herein.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIGS. 1I through 1L are schematic diagrams of corresponding media playback system zones.

FIG. 1M is a schematic diagram of media playback system zones and areas.

FIG. 2A illustrates an example of a multi-zone device with a flexible user interface, in accordance with embodiments described herein.

FIGS. 2B-2L illustrate example instances of a flexible user interface of a multi-zone device, in accordance with embodiments described herein.

FIG. 3 illustrates a flowchart of a method of updating a user interface, in accordance with embodiments described herein.

FIGS. 4A-4C illustrate additional example instances of a flexible user interface of a multi-zone device, in accordance with embodiments described herein.

FIG. 5 illustrates example functional blocks of an example multi-zone device, in accordance with embodiments described herein.

FIGS. 6A and 6B illustrate additional example instances of a flexible user interface of a multi-zone device, in accordance with embodiments described herein.

FIG. 7 illustrates an example scenario including two multi-zone devices, in accordance with embodiments described herein.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Some devices in a media playback system include user interfaces to convey information to the users of the system. In some cases, the user interfaces provide information about the system's configuration or operating state. For example, some devices can include a light to indicate that the device is turned on and ready to use. However, for devices that provide a larger variety of options and that are capable of operating in multiple different configurations, user interfaces can become complex and counterintuitive. Providing a user interface that is simple but still capable of conveying a wide range and depth of information about all the different operating states and modes of a highly configurable device can be challenging.

Multi-zone devices in a media playback system are an example of a highly configurable device that would benefit from a flexible user interface capable of reflecting the level of flexibility that the device can offer. Example multi-zone devices are described in U.S. Prov. App. No. 63/502,347, filed May 15, 2023, titled “Area Zones”, U.S. Prov. App. No. 63/571,312, filed Mar. 28, 2024, titled “Multi-Instance Architecture for Multi-Player Playback Device”, and U.S. Prov. App. No. 63/571,313, filed Mar. 28, 2024, entitled “Multi-Stream Audio Routing for Multi-Player Playback Device”, all of which are incorporated herein by reference in their entirety.

A multi-zone device can include multiple media outputs, and be capable of facilitating implementation of multiple playback zones. Each playback zone can be associated with one or more of the media outputs of the multi-zone device so that the multi-zone device can facilitate implementation of those zones via the outputs. For example, the multi-zone device can facilitate implementation of (and/or implement one or more aspects of) the playback zones by providing, hosting, powering, driving, operating, managing, handling one or more aspects of the playback zones via the outputs, and/or by communicating with the playback zones (e.g., to transmit content for playback to the playback devices in the zones via the outputs).

In some instances, the number of playback zones implemented by the multi-zone device, and/or the number of outputs associated with the playback zones, can be dynamically configured and updated. For these types of multi-zone devices, it could be beneficial to provide a visual user interface that provides zone configuration information so that a user can obtain the current zone configuration by simply glancing at the device. However, as previously mentioned, providing a user interface that efficiently reflects this level of flexibility can be challenging. There is therefore a need for a simple but versatile user interface that can be used with these types of highly configurable devices.

Embodiments described herein provide a user interface for a multi-zone device. The user interface can be dynamically updated to reflect the current playback zone configuration. In some instances, the user interface can comprise a set of regions. Each region in the set of regions can correspond to an audio output of the multi-zone device. The user interface can be updated by updating the appearance of one or more of the regions of the user interface with visual indications. The visual indications can comprise lights, colors, shapes, text, numbers, icons, images, animations, videos, or any other suitable visual indication. The visual indications can be provided in a way so as to reflect the current playback zone configuration. For example, a visual indication representative of a particular zone can be provided on at least part of the regions of the user interface that correspond to the outputs associated with that particular zone. In this way, the user interface can reflect the playback zone configuration.

As a practical example, a user interface of a multi-zone device comprising two outputs can include a first region corresponding to the first output and a second region corresponding to the second output. The multi-zone device can be configured to drive two different playback zones, one via the first output and another via the second output. For example, the multi-zone device can be an amplifier configured to drive a Kitchen zone (e.g., one or more playback devices in the kitchen) via the first output and a Dining Room zone (e.g., one or more playback devices in the dining room) via the second output. In this case, the user interface can include a first visual indication corresponding to the Kitchen zone and a second visual indication corresponding to the Dining Room zone.

The visual indications can be provided via the user interface at a position that represents or corresponds to the outputs they are associated with. For example, the first visual indication corresponding to the Kitchen zone can be provided in the first region of the user interface corresponding to the first output of the multi-zone device. Similarly, the second visual indication corresponding to the Dining Room zone can be provided in the second region of the user interface corresponding to the second output of the multi-zone device. In this case, the visual indications can be different to indicate the fact that the two outputs are associated with different zones. In some instances, the visual indications can be different in that they are separate from one another. For example, the visual indications can be visually separated from one another. In some instances, the visual indications are different in that they have different characteristics (e.g., a different color, shape, pattern, etc.).

Continuing with the example above of the user interface of the multi-zone device comprising two outputs, in an alternative configuration, the multi-zone device can be configured to power a single zone via the first output and the second output. For example, the multi-zone device can be configured to power a Lounge zone or area that comprises the Kitchen (and/or at least part of the Kitchen playback devices) and the Living Room (and/or at least part of the living room playback devices). In this scenario, the user interface could be updated to as to reflect the fact that the two outputs are now associated with the same zone. For example, the user interface can include a visual indication corresponding to the Lounge zone.

The visual indication can be provided via the user interface at a position that represents or corresponds to the outputs it is associated with. For example, the visual indication can be provided in the first region of the user interface corresponding to the first output of the multi-zone device and in the second region of the user interface corresponding to the second output of the multi-zone device. In this case, the visual indication can be the same for the first region and the second region to indicate the fact that the two outputs are associated with the same zone. In some instances, the visual indication can be the same in that it is a unique/single visual indication for the entire zone (e.g., extending to both the first region and the second region). In some instances, however, the visual indications for a single zone can be separate from one another (e.g., one in each region), but are the same in that they have a characteristic in common to indicate that they relate to the same zone (e.g., a same color, shape, pattern, etc.).

In some embodiments, for example, a multi-zone device is provided. The multi-zone device comprises one or more network interfaces, a set of audio outputs comprising at least a first audio output and a second audio output, a user interface comprising a set of regions, the set of regions comprising at least a first region corresponding to the first audio output and a second region corresponding to the second audio output, at least one processor, and at least one non-transitory computer-readable medium comprising program instructions that are executable by the at least one processor such that the multi-zone device is configured to: receive, via the one or more network interfaces, data corresponding to a playback zone configuration indicating one or more playback zones to be implemented via the multizone playback device, wherein each playback zone is associated with respective one or more audio outputs in the set of audio outputs; and based on the data corresponding to the playback zone configuration, update, with one or more visual indications, the appearance of one or more regions in the set of regions, the one or more regions corresponding to the respective one or more audio outputs associated with the one or more playback zones, so that the user interface reflects the playback zone configuration.

When the data corresponding to the playback zone configuration indicates one or more of: (i) a first playback zone associated with the first audio output or (ii) a second playback zone associated with the second audio output: updating the appearance of the one or more regions comprises one or more of: (i) updating, with a first visual indication, the appearance of the first region corresponding to the first audio output; or (ii) updating, with a second visual indication, the appearance of the second region corresponding to the second audio output; wherein the first visual indication is different from the second visual indication.

When the data corresponding to the playback zone configuration indicates a playback zone associated with both the first audio output and the second audio output: updating the appearance of the one or more regions comprises updating, with a third visual indication, the appearance of both the first region corresponding to the first audio output and the second region corresponding to the second audio output, wherein the third visual indication is the same for both the first region and the second region.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

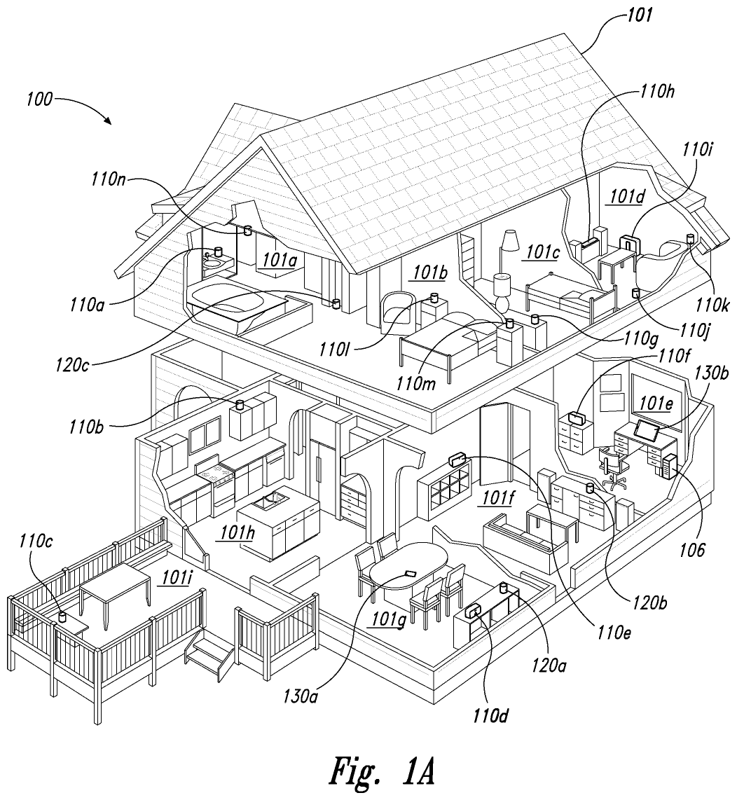

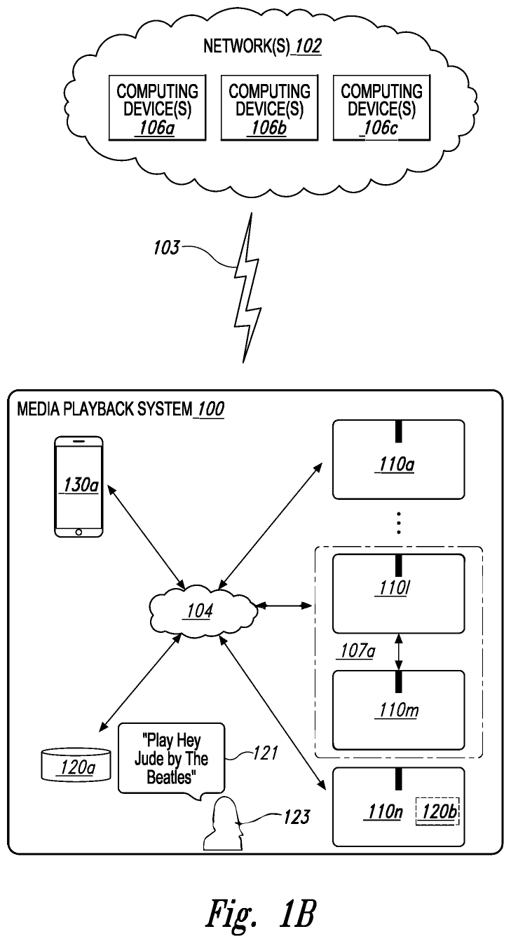

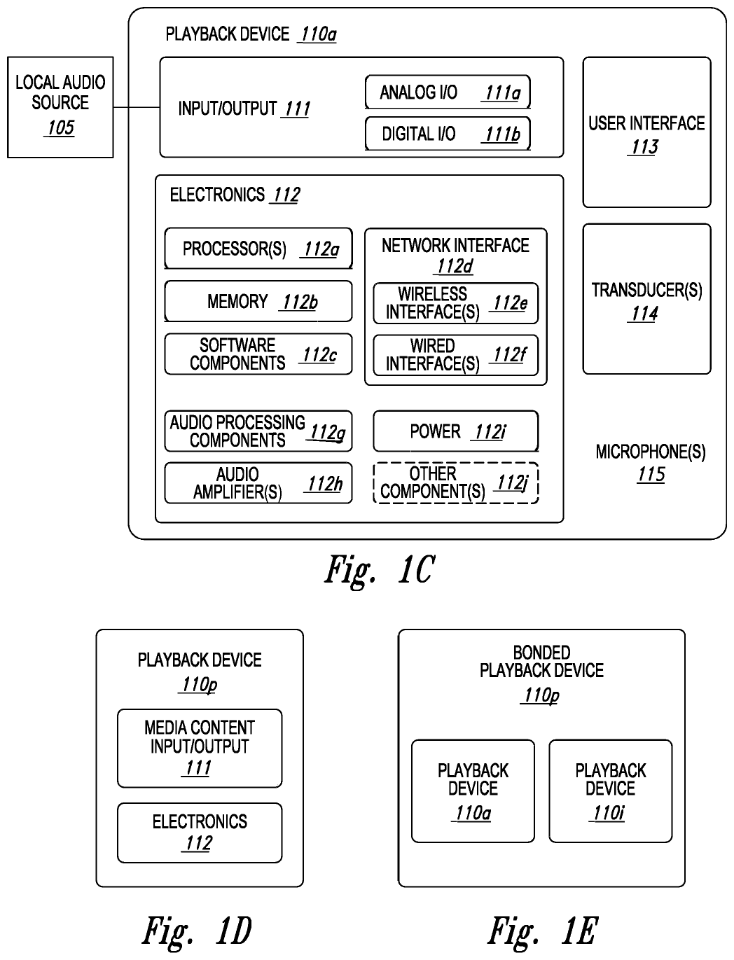

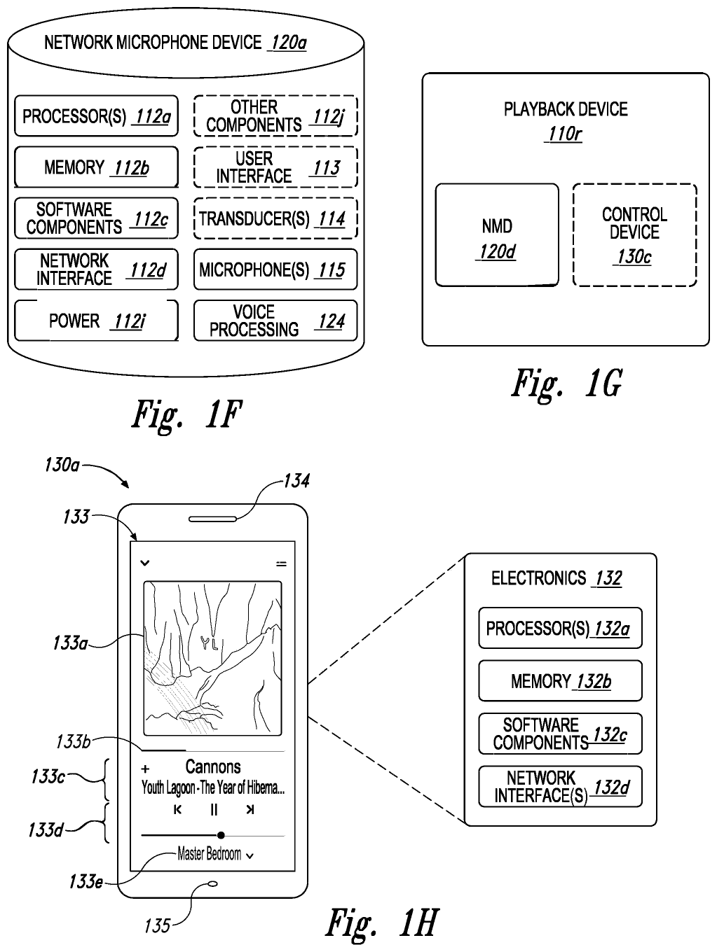

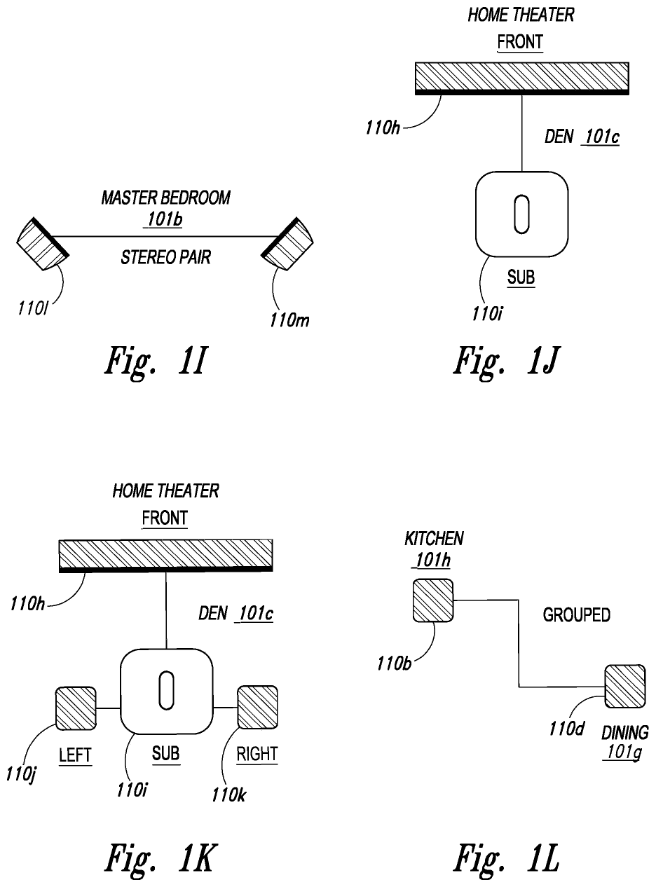

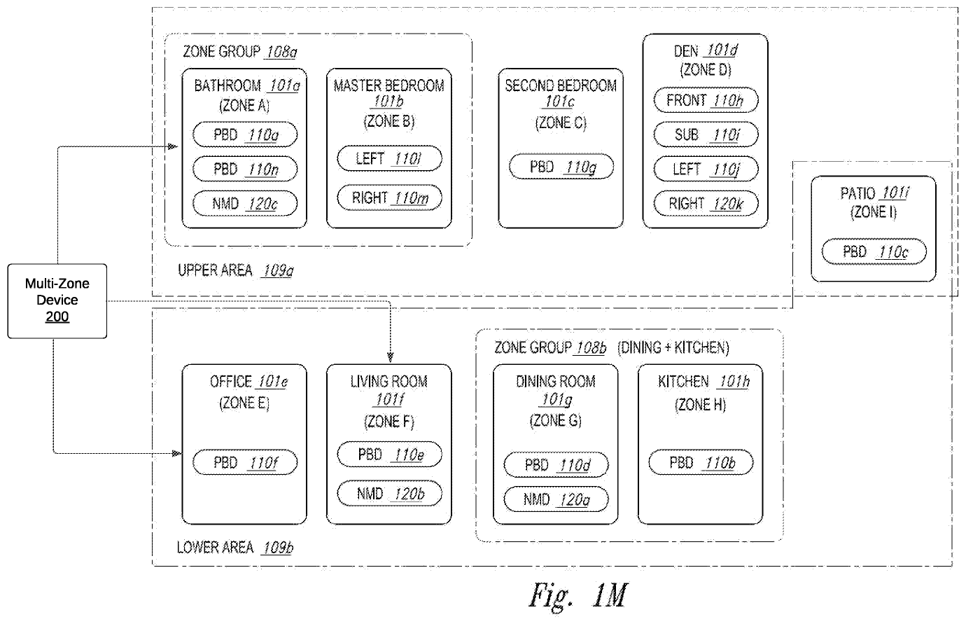

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1M.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1-I through IM.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises an High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others. Additional description of zones and groups can be found below with respect to FIGS. 1-I through 1M.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

e. Suitable Playback Device Configurations

FIGS. 1-1 through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110l (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1-I, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can have be assigned a name such as “Dining+Kitchen”, as shown in FIG. 1M. In some embodiments, a zone group may be given a unique name selected by a user.

Certain data may be stored in a memory of a playback device (e.g., the memory 112c of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “al” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the media playback system 100 may not implement Areas, in which case the system may not store variables associated with Areas.

### III. Flexible User Interface for Multi-Zone Device

In some instances, a multi-zone device 200 can be used to facilitate implementation of one or more playback zones in a media playback system, such as one or more of the example payback zones and/or areas described with reference to FIG. 1M. Example multi-zone devices are described in U.S. Prov. App. No. 63/502,347, filed May 15, 2023, titled “Area Zones”, U.S. Prov. App. No. 63/571,312, filed Mar. 28, 2024, titled “Multi-Instance Architecture for Multi-Player Playback Device”, and U.S. Prov. App. No. 63/571,313, filed Mar. 28, 2024, entitled “Multi-Stream Audio Routing for Multi-Player Playback Device”, which are incorporated by reference in their entireties.

In some instances, a multi-zone device comprises a multi-zone amplifier. The playback devices in the different zones powered by the multi-zone amplifier can be passive playback devices, and the amplifier can facilitate implementation of the playback zones by driving and/or powering the passive playback devices. In some instances, the multi-zone device comprises any device capable of implementing or “hosting” two or more playback zones. Implementing or “hosting” a playback zone can include one or more actions to facilitate operation of the playback zone, such as instantiating one or more software modules corresponding to the zone that perform functions to enable playback, control and/or operation of the zone, receiving and routing commands to the zones (and/or playback devices in the zone), retrieving, processing and transmitting content to the zones (and/or playback devices in the zone), etc. The multi-zone device can facilitate implementation of the one or more zones by providing, hosting, powering, driving, operating, managing, handling one or more aspects of the playback zones via the outputs, and/or by communicating with one or more devices in the playback zones (e.g., to transmit content for playback to the playback devices in the zones via the outputs).

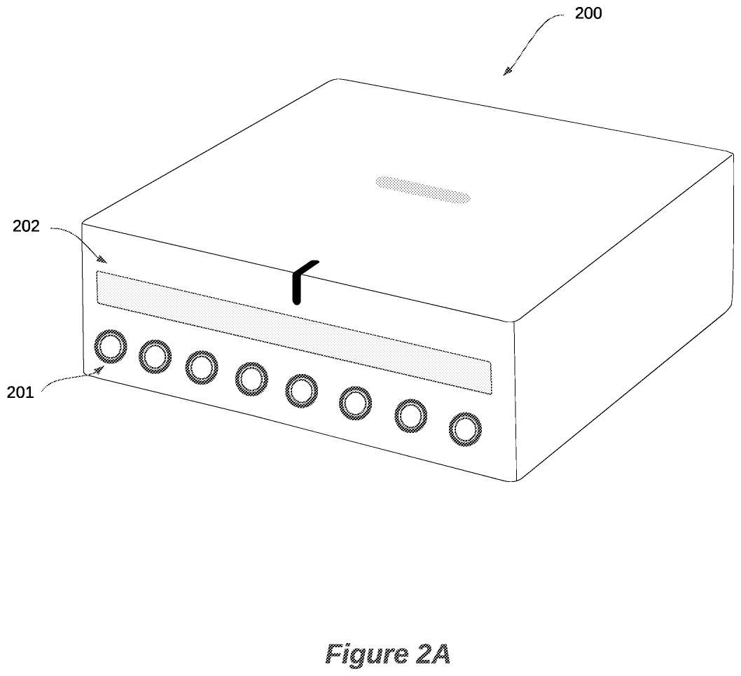

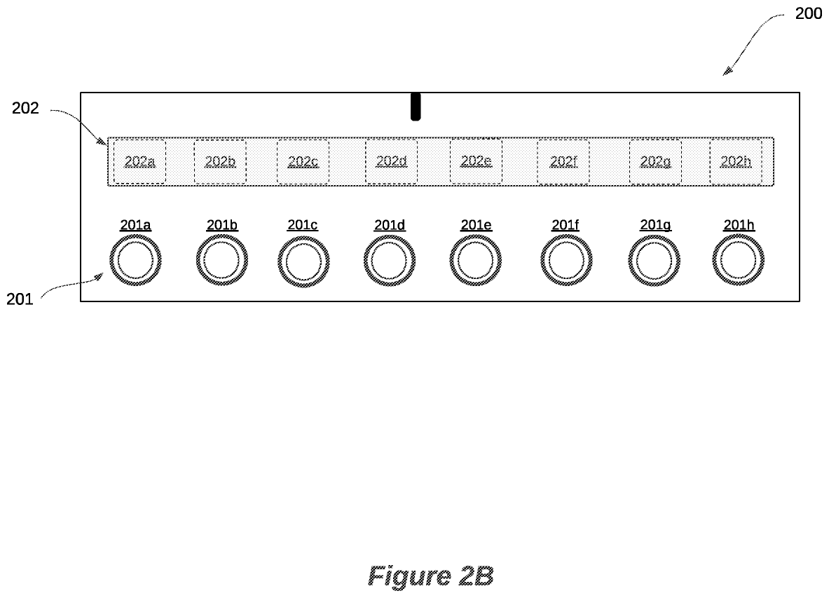

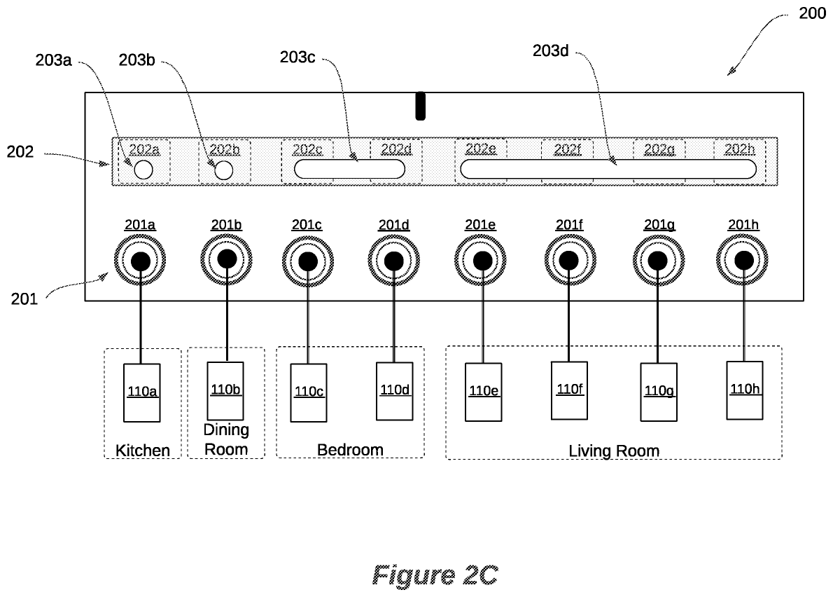

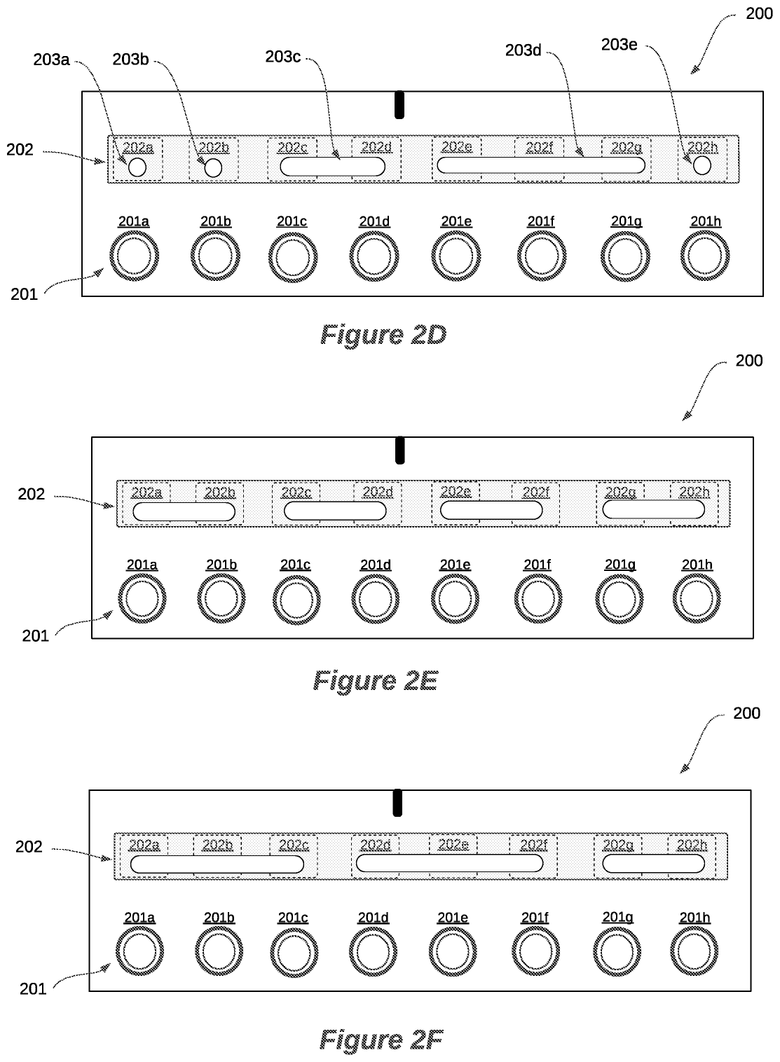

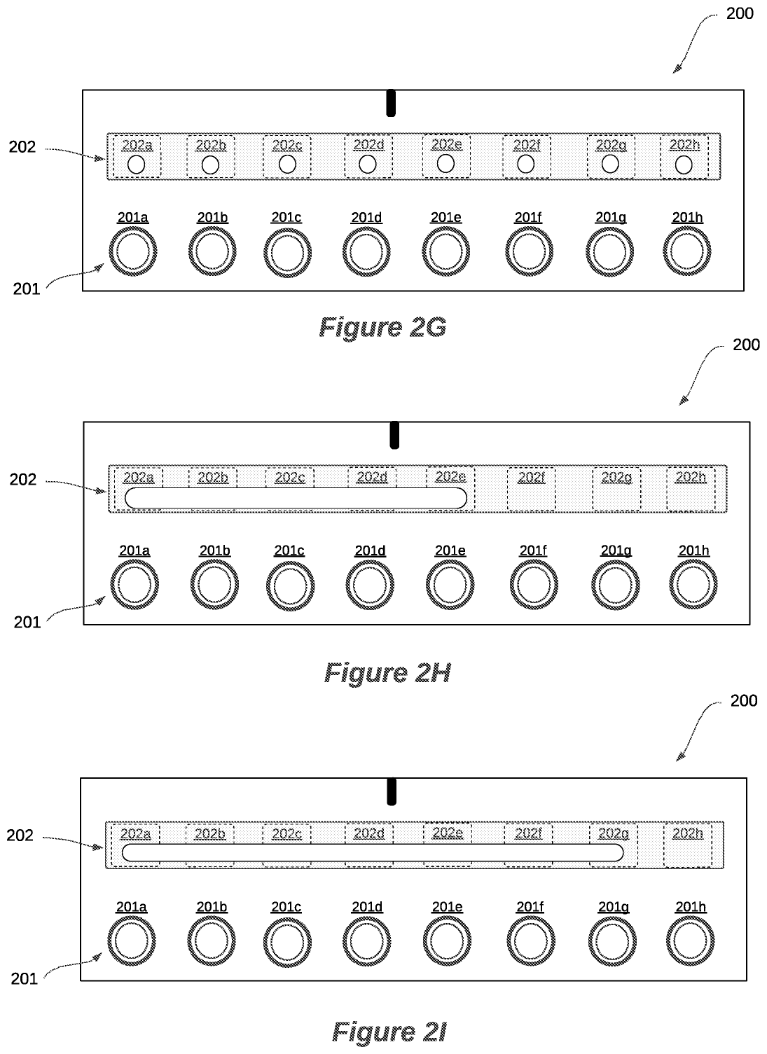

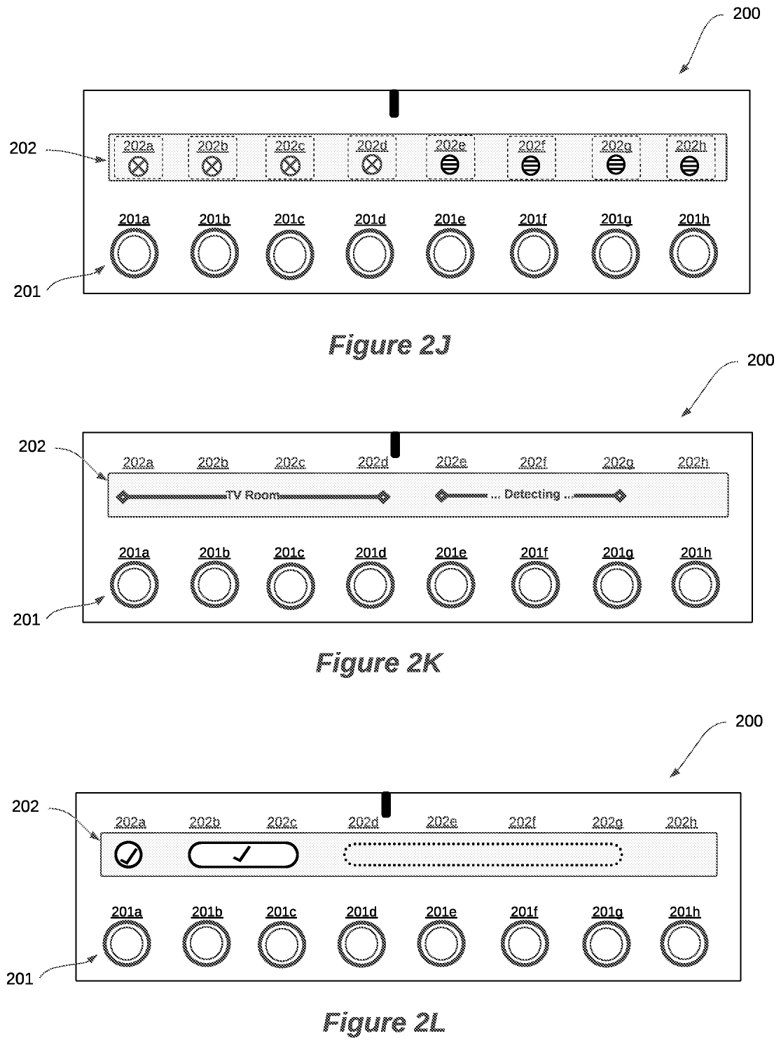

FIG. 2A includes an example of a multi-zone device 200, in accordance with embodiments described herein. The multi-zone device can include a set of outputs 201 and a user interface 202. The type and form factor of the example multi-zone device 200 are for illustrative purposes only. The multi-zone device can take any other form, and be implemented by any type of device, such as any of the playback devices 110 described before with reference to FIGS. 1A-1M.

Similarly, the type and form factor of the set of outputs 201 and the user interface 202 are for illustrative purposes only. The set of outputs can take any other suitable form and be distributed differently around the multi-zone device 200. The user interface 202 can also take any other suitable form and be distributed differently around the multi-zone device 200. The set of outputs 201 and user interface 202 are illustrated on the same surface of the example multi-zone device 200 for illustrative purposes only. In some instances, the set of outputs 201 and user interface 202 can be on the same surface or side of the multi-zone device (e.g., on the back of the device). In other instances, the set of outputs 201 and user interface 202 can be on different surfaces or sides of the multi-zone device (e.g., the set of outputs 201 can be on the back of the device and the user interface 202 can be on the front or top of the device). Any other placement is possible.

The set of outputs 201 can include one or more media outputs such as audio outputs and/or video outputs. In some instances, the set of outputs comprises at least 2 outputs. In some instances, the set of outputs comprises at least 4 outputs, at least 6 outputs, or at least 8 outputs. Any other number of outputs is possible. The outputs can comprise banana plug outputs, HDMI outputs, USB outputs, or any other type of suitable A/V or media outputs. The user interface 202 can comprise a visual user interface such as a display, one or more lights (e.g., one or more LEDs, an LED strip, light bar, etc.), or any other suitable user interface.

FIG. 2B illustrates a more detailed view of the set of outputs 201 and user interface 202 of the example multi-zone device 200. As mentioned before and illustrated in FIG. 2B, the set of outputs can comprise one or more outputs such as outputs 201a, 201b, 201c, 201d, 201e, 201f, 201g and 201h (collectively referred to herein as set of outputs 201 or outputs 201). In some instances, and as also illustrated in FIG. 2B, the user interface 202 can comprise a set of regions such as regions 202a, 202b, 202c, 202d, 202e, 202f, 202g and 202h (collectively referred to herein as set of regions of the user interface 202 or regions of the user interface 202).

In some instances, each region in the set of regions of the user interface 202 corresponds to an output in the set of outputs 201. With a 1 to 1 correspondence between regions in the set of regions 202 and outputs in the set of outputs 201, each region in the user interface can reflect one or more aspects of a status of the corresponding output in the set of outputs 201. For example, region 202a can correspond to output 201a and reflect a status of output 201a, region 202b can correspond to output 201b and reflect a status of output 201b, and so on.

In some instances, the appearance of one or more of the regions of the user interface 202 can be updated with visual indications so that the user interface reflects the current playback zone configuration of the multi-zone device 200. For example, the multi-zone device 200 can receive data corresponding to a playback zone configuration indicating one or more playback zones to be implemented via the multi-zone playback device. Each playback zone can be associated with one or more outputs in the set of outputs 201. Based on the playback zone configuration information, the multi-zone playback device can update, with one or more visual indications, the appearance of one or more regions in the set of regions corresponding to the respective one or more outputs associated with the one or more playback zones, so that the user interface reflects the playback zone configuration.

FIG. 2C illustrates an example of the user interface 202 of the multi-zone device 200 comprising one or more visual indications such as visual indications 203a, 203b, 203c, and 203d (collectively referred to herein as a set of visual indications 203 or visual indications 203). As mentioned, the visual indications can be provided in order to reflect current zone configuration of the multi-zone device.

In the example of FIG. 2C, the multi-zone device 200 can be configured to implement (e.g., provide and/or manage) a first playback zone via output 201a by, for example, transmitting and/or routing media content to a first playback device in the first playback zone via the output 201a. For example, the multi-zone device 200 can be configured to implement a Kitchen playback zone comprising at least one playback device 110a connected to the multi-zone device via output 201a. The appearance of the user interface 202 can be updated to reflect this zone configuration. For example, region 202a corresponding to output 201a can be updated to display or otherwise show a visual indication 203a representative of the first zone.

In a similar example, the multi-zone device 200 can be further configured to implement a second playback zone via output 201b (e.g., to transmit and/or route media to a second playback device in the second playback zone via the output 201b). For example, the multi-zone device 200 can be configured to implement a Dining Room playback zone comprising at least one playback device 110b connected to the multi-zone device via output 201b. The appearance of the user interface 202 can be updated to reflect this zone configuration. For example, region 202b corresponding to output 201b can be updated to display or otherwise show a visual indication 203b. In this way, the user interface 202 could reflect the current zone configuration (e.g., two individual zones) and the corresponding outputs associated with those zones (201a and 201b) via the corresponding visual indications 203a and 203b.

The two previous examples refer to situations in which each zone is associated with a single output of the multi-zone device 200. However, the user interface can be likewise updated to reflect zones that are associated with multiple outputs. For example, the multi-zone device 200 can be configured to implement a third playback zone via outputs 201c and 201d (e.g., to transmit and/or route media to playback devices in the third zone via outputs 201c and 201d). For example, the multi-zone device 200 can be configured to implement a Bedroom playback zone comprising at least two playback devices 110c and 110d connected to the multi-zone device via outputs 201c and 201d. The appearance of the user interface 202 can be updated to reflect this zone configuration. For example, regions 202c and 202d corresponding to outputs 201c and 201d can be updated to display or otherwise show a visual indication 203c. As illustrated, the visual indication 203c corresponding to a zone associated with multiple outputs can be the same indication for all the regions of the user interface corresponding to the outputs of the zone. In some instances and as illustrated in the example of FIG. 2C, the visual indication for a same zone such as visual indication 203c is a continuous visual element (e.g., bar) connecting the regions 202c and 202d to indicate that corresponding outputs 201c and 201d are together configured as the Bedroom zone. The visual indication 203c can be a continuous visual indication (e.g., a bar or string of light or other indication) extending or overlapping at least a portion of each of the corresponding regions of the user interface 202c and 202d. In this way, it can be more evident to users that the particular outputs corresponding to those regions are associated with the same playback zone.

In a similar example, the multi-zone device 200 can be configured to implement a fourth playback zone via outputs 201e, 201f, 201g and 201h. For example, the multi-zone device 200 can be configured to implement a Living Room playback zone comprising at least four playback devices 110e-110h connected to the multi-zone device via outputs 201e-201h where each playback device is connected to a single output. The appearance of the user interface 202 can be updated to reflect this zone configuration. For example, regions 202e, 202f, 202g, and 202h can be updated to display or otherwise show a visual indication 203d. As illustrated, the visual indication 203d corresponding to a zone associated with multiple outputs can be the same indication for all the regions of the user interface corresponding to the outputs of the zone. In this way, it can be more evident to users that the particular outputs are associated with a same playback zone.

The example user interface 202 illustrated in FIG. 2C conveys zone configuration information to the user in a simple and efficient manner. By simply glancing at the user interface 202, a user could easily determine that the multi-zone device 200 is currently configured to implement four playback zones (e.g., by noticing the four different and/or separate visual indications 203), and the particular outputs corresponding to each of those four zones (e.g., by noticing the corresponding regions of the user interface 201 where each of the visual indications 203 is provided). Furthermore, the user can quickly determine which zones comprise multiple playback devices and/or are associated with multiple outputs of the multi-zone device 200 (e.g., by noticing how many corresponding regions of the user interface each visual representation occupies). Each of the visual indications 203 could provide additional information about the zone. For example, each of the visual indications 203 could include a name of the zone, a status of the zone, etc. Furthermore, the visual indications can be selectable so that the user can select a particular visual indication to obtain more information and/or control a zone.

The user interface 202 can be dynamically updated (e.g., via visual indications such as visual indications 203) to reflect current zone configuration. As the zone configuration changes, the information represented via the user interface 202 through the visual indications 203 can change to reflect current playback zone configuration. For example, different visual indications can be provided at the particular regions of the user interface such as visual indication 203a at a first location within region 202a and visual indication 203b at a second location within region 202b. These visual indications are not connected (i.e., separate) when they represent separate zones (Kitchen and Dining Room zones). However, when these outputs are configured to be part of the same zone, a visual element connecting the regions between the two locations can be displayed or otherwise shown to represent the new zone.

As another example, if output 201h is dissociated from the Living Room zone and associated with another zone (e.g., a Patio zone), the user interface can be updated so that visual indication 203d is separated (e.g., a visual element connecting regions 202g and 202h can be removed) and/or so that another, different visual indication is used in region 203h corresponding to the new Patio zone associated with output 201h, as illustrated in FIG. 2D.

FIG. 2D illustrates an example of another instance of the user interface 202 where a new visual indication 203e has been provided to update the appearance of region 202h corresponding to output 201h. This update reflects the new zone configuration. As illustrated, visual indication 203d corresponding to the Living Room zone is the same for regions 202e-202g, corresponding to outputs 201e-201g (assuming those outputs are still associated with the Living Room zone), but the visual indication 203e in region 202h is different (e.g., separate), so as to reflect the current playback zone configuration. In this example, the user could have split the Living Room zone (represented by visual indication 203d in FIG. 2C) into two different zones. Each of the two different zones will have its own, independent visual indication, as represented in the updated user interface of FIG. 2D.

The user interface of the multi-zone device 200 can be updated to many other different configurations as the zone configuration of the multi-zone device changes. For example, FIG. 2E illustrates another instance of the user interface 202 where the multi-zone device can be configured to implement four independent zones. Each zone can be associated with two outputs (e.g., two audio channels per zone, one output per audio channel). As another example, FIG. 2F illustrates another instance of the user interface 202 where the multi-zone device can be configured to implement three independent zones, two zones associated with three outputs or channels and one associated with two outputs or channels.

As yet another example, FIG. 2G illustrates another instance of the user interface 202 where the multi-zone device can be configured to implement eight independent zones, each zone associated with one output or channel. As yet another example, FIG. 2H illustrates another instance of the user interface 202 where the multi-zone device can be configured to implement one independent zone associated with five outputs or channels. In this configuration, the multi-zone device could be used, for example, to provide the five channels of a 5.1 home theater system (where the subwoofer could be connected to the system via any means such as wirelessly or via a subwoofer output of the multi-zone device).

As yet another example, FIG. 2I illustrates another instance of the user interface 202 where the multi-zone device can be configured to implement one independent zone associated with seven outputs or channels. In this configuration, the multi-zone device could be used, for example, to provide the seven channels of a 7.1 or a 5.1.2 home theater system (where the subwoofer could be connected to the system via any means such as wirelessly or via a subwoofer output of the multi-zone device). Many other examples are possible.

As illustrated with the examples above, the user interface 202 can easily adapt to any of the many potential configurations of the multi-zone device 200.

In the examples provided above, the visual indications extend over at least a portion of the regions corresponding to the outputs of the particular zone they represent. In these examples, for zones associated with multiple outputs, a same (e.g., single or unique) visual indication is provided by zone. However, other examples are possible. For example, separate visual indications can be used for regions corresponding to a same zone, as long as they share at least one characteristic in common so that it is clear that they are associated with the same zone.

FIG. 2J illustrates an example of another instance of the user interface 202 where the multi-zone device can be configured to implement a first zone associated with outputs 201a-201d and a second zone associated with outputs 201e-201h. As illustrated, separate visual indications are provided for each region of the user interface. However, the visual indications in regions 202a-202d corresponding to outputs 201a-201d (associated with the first zone) are the same type of visual indication or have a characteristic in common. The common characteristic can be a color, a shape, a pattern, or any other suitable characteristic. Similarly, the visual representations for regions 202e-202h corresponding and outputs 201e-201h (associated with the second zone) are the same type of visual indication or have a characteristic in common, but are different or have different characteristics from the visual indications in regions 202a-202d corresponding to the first zone. In this way, it can be easy to determine which outputs are associated with the same or different zones.

The visual indications can take any form. For example, the visual indications can include any one or more of a light, a color, a graphical indication such as an icon or an image, a text or numeric descriptor, etc. FIG. 2K illustrates an example of another instance of the user interface 202 where the multi-zone device can be configured to implement a first zone associated with outputs 201a-201d and a second zone associated with outputs 201e-201g. As illustrated, the visual indications in user interface 202 comprise a text descriptor. The text descriptor can indicate additional information such as the name of the particular zone (“TV Room”), a status of a particular zone (e.g., “detecting”, “active”, “idle”, “paused”, “error”), etc. As another example, FIG. 2L illustrates an example of another instance of the user interface 202 where the multi-zone device can be configured to implement a first zone associated with output 201a, a second zone associated with outputs 201b and 201c and a third zone associated with outputs 201d-201g. As illustrated, the visual indications comprise a graphical representation such as an image or icon. The graphical representation can indicate additional information such as a status of the zone. For example, a check mark can indicate that the zone is configured and ready to play back content. A dotted-out zone can indicate that the zone is not yet configured or indicate an issue that needs resolution. Other examples are possible.

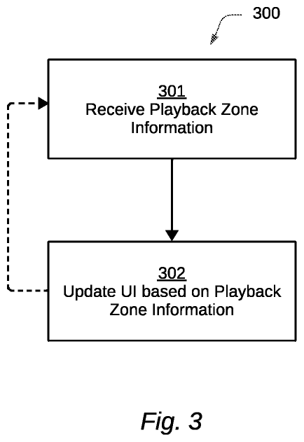

FIG. 3 illustrates a flowchart of a method 300 of updating a user interface, in accordance with embodiments described herein. Method 300 can be performed by a multi-zone device such as multi-zone device 200, or by any device that comprises at least one processor and at least one non-transitory computer-readable medium comprising program instructions that are executable by the at least one processor such that the device is configured to execute the blocks of the method. Method 300 can provide any of the example user interfaces described above with reference to FIGS. 2C-2L.

Method 300 comprises a block 301 of receiving playback zone configuration information. In some instances, block 301 comprises receiving data corresponding to a playback zone configuration indicating one or more playback zones to be implemented via the multi-zone playback device. As will be described in more detail below, the multi-zone device can receive the playback zone information from a user, and/or from/via one or more devices such as a control device of a media playback system associated with the multi-zone device, a playback device of the media playback system associated with the multi-zone device, a smart device or user device in communication with the multi-zone device, a cloud computing device, etc. The playback zone information can be received via one or more network interfaces of the multi-zone device.

Method 300 further comprises a block 302 of updating the user interface based on the playback zone configuration information received in block 301. In some instances, block 302 involves updating, with one or more visual indications, the appearance of one or more regions in the set of regions, the one or more regions corresponding to the respective one or more outputs associated with the one or more playback zones, so that the user interface reflects the playback zone configuration.

Method 300 can be performed any number of times so that the user interface illustrates updated playback information. In some instances, the multi-zone device updates the user interface as soon as updated playback zone information is received in block 301. Playback zone information can be received at any time such as when the device is turned on, when there is a change to the current playback zone configuration, when a new zone is created, when a zone is modified (e.g., when one output is associated/dissociated with/from a zone), etc. In some instances, the multi-zone device can be configured to detect a change in playback zone configuration and update the user interface based on detected change.

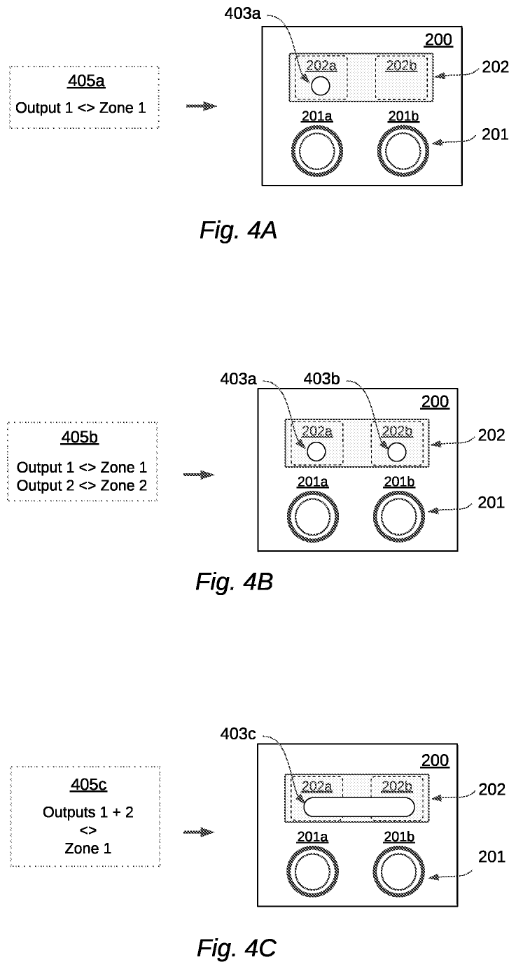

FIGS. 4A-4C illustrate example visual indications that could be provided upon execution of method 300, via a user interface such as user interface 202 of multi-zone device 200. In the examples illustrated in FIGS. 4A-4C, the multi-zone device comprises a set of outputs 201 comprising at least a first output 201a and a second output 201b. Furthermore, the multi-zone device comprises a set of regions comprising at least a first region 202a corresponding to the first output 201a and a second region 202b corresponding to the second output 201b. As explained before, each region in the set of regions can correspond to an output in the set of outputs.

FIG. 4A illustrates an example in which the playback zone configuration information 405a indicates a first playback zone associated with the first output. This playback zone configuration information can be received, for example, from a user device via which the user indicated that they wish to configure a zone associated with the first output. In this case, the playback zone information indicates a first playback zone associated with the first audio output, and the user interface can be updated by displaying, activating or otherwise showing a first visual indication such as 403a positioned in the first region 202a corresponding to the first audio output 201a.

FIG. 4B illustrates an example in which the playback zone configuration information 405b indicates a first playback zone associated with the first audio output and a second playback zone associated with the second audio output. In this case, the user interface can be updated by updating, with a first visual indication 403a, the appearance of the first region 202a corresponding to the first audio output 201a and updating, with a second visual indication 403b, the appearance of the second region 202b corresponding to the second audio output 201b. The first visual indication 403a can be different (e.g., separate and/or different in one or more aspects) from the second visual indication 403b to as to indicate that they correspond to different zones.

FIG. 4C illustrates an example in which the playback zone configuration information 405c indicates a playback zone associated with both the first output and the second audio output. In this case, the user interface can be updated by updating, with a third visual indication 403c, the appearance of both the first region 202a corresponding to the first output 201a and the second region 202b corresponding to the second output 201b. As illustrated, the third visual indication 403c can be the same for both the first region and the second region.

As mentioned before, in some instances, visual indications corresponding to a particular zone can be provided on at least portions of the regions that correspond to the outputs associated with that particular zone. In some instances, the visual indications are provided in the corresponding regions without extending to or not overlapping with other regions of the user interface (e.g., without extending to or not overlapping with regions corresponding to other outputs that are not associated with the particular zone). For example, the first visual indication 403a in the example of FIG. 4A extends over at least a portion of the first region 202a without extending to the second region 202b. Similarly, the second visual indication 403b in the example of FIG. 4B extends over at least a portion of the second region 202b without extending to the first region 202a.

In some instances, visual indications corresponding to different zones can be different visual indications. In some instances, visual indications corresponding to different zones can be different visual indications in that they are separate visual indications. For example, the first visual indication is different from the second visual indication at least in that the first visual indication is separate from the second visual indication, as in the example of FIG. 4B, where the first and second visual indications corresponding to different zones are different/separate visual indications.

In some instances, visual indications corresponding to different zones can be different in at least one characteristic. For example, a first visual indication corresponding to a first zone can be different from a second visual indication corresponding to a second zone in at least one characteristic. The at least one characteristic can include a color (e.g., a first visual indication for a first zone can be of a first color or shade, and a second visual indication for a second zone can be of a different color or shade, so as to clearly identify the two different zones), a shape, a design, a pulsing pattern or frequency, a text or other description, an animation, or any other suitable characteristic that serves to differentiate a visual indication for a zone from others for other zones.

In some instances, visual indications corresponding to zones associated with more than one output can extend multiple regions of the user interface. For example, the third visual indication 403c in the example of FIG. 4C extends over at least a portion of both the first region 202a and the second region 202b, corresponding to outputs 201a and 201b, both associated with a same zone. In this way, a same visual indication can be used to identify a same zone. In some instances, however, separate visual indications can be used to identify a same zone. For example, the third visual indication 403c could comprise a first part of the third visual indication in the first region and a second part of the third visual indication in the second region. These first and second parts may or may not overlap. In some instances, the first part can be separate from the second part (e.g., similar to the example of FIG. 4B). However, the first part and the second part might have at least one characteristic in common so as to reflect the fact that they represent a same zone. For example, all the parts of a visual indication corresponding to a same zone can have a same color or shade, a same pulsing pattern, a text or other descriptor, an animation, or any other suitable characteristic in common.

In some instances, as illustrated in the previous figures, the set of regions are distributed along a linear surface of the user interface. Updating the appearance of the one or more regions can comprise enabling, activating, or displaying the one or more visual indications located within portions of the linear surface corresponding to the one or more regions. Activating the portions of the linear surface with the one or more visual indications comprises displaying or otherwise showing within the portions of the linear surface one or more of a light, a color, an image, a video, a graphical indication, a text descriptor, etc.

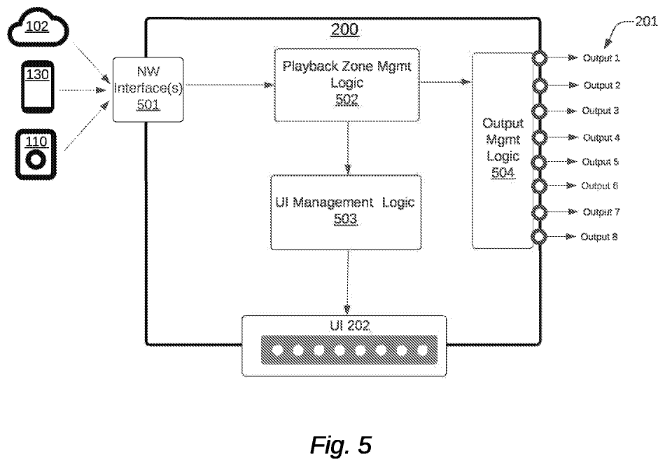

FIG. 5 illustrates example functional blocks of an example multi-zone device such as multi-zone device 200 capable of executing the blocks of the method 300 described with reference to FIG. 3. The multi-zone device 200 can include one or more network interfaces 501, a playback zone management logic 502, a user interface management logic 503, an output management logic 504, a user interface such as user interface 202, and a set of outputs such as set of outputs 201.

The multi-zone device can include one or more network interfaces 501 such as any of the network interfaces described before in this disclosure. The playback zone information received in block 301 of method 300 can be received from/via any one or more devices or networks via the one or more network interfaces. In some instances, the playback zone information can be received from/via a cloud computing system or cloud computing device such as any of the cloud computing systems described with reference to networks 102 in FIG. 1B. For example, a user such as an installer could provide the zone configuration via a web dashboard, and the corresponding playback zone information can then be sent via the cloud network to the multi-zone device for implementation of the playback zone configuration and corresponding update to the user interface.

In some instances, the playback zone information is received by/via a control device 130 of a media playback system associated with the multi-zone device. For example a user could provide the zone configuration information via a user interface of the control device, and the control device could transmit the information to the multi-zone device. The user can provide the playback zone information in various ways. For example, the user could create and/or name zones, select which outputs (or playback devices connected to such outputs) to associate with which zones, etc.

In some instances, the playback zone information can be received from a playback device 110 of the media playback system associated with the multi-zone device. The playback device can be a playback device connected to the multi-zone device via one of the outputs 201, or any other playback device in the system. For example, a user could issue a voice command to a playback device to create a zone comprising two playback devices connected to two different outputs of multi-zone device 200. The playback device can receive the voice command and transmit corresponding information to the multi-zone device for implementation of the zone configuration and corresponding update to the user interface. Other examples are possible. Alternatively, the playback device could receive the zone information from another device (e.g., a cloud server or another playback device), and forward that information to the multi-zone device. In some instances, the playback zone information can be received via user interface of the multi-zone device itself (e.g., voice, touch, etc.)

As illustrated in the block diagram of the example multi-zone device 200, the multi-zone device can also include a playback zone management logic 502. The playback zone management logic can include one or more hardware and/or software modules configured to manage the playback zones. In some instances, the playback zone management logic can be configured to receive and process playback zone configuration information to implement the playback zones. For example, the playback zone management logic can be configured to instantiate one or more software modules that can form logical playback entities corresponding to each zone, associate outputs with the logical playback entities, route media to the respective outputs, etc. In some instances, the playback zone management logic is configured to receive zone information and based on the zone information, cause the multi-zone device to implement the zone configuration (e.g., instantiate playback entities corresponding to each zone, associate respective outputs with respective zones, etc.) and further cause the multi-zone device to update the user interface to reflect the playback zone configuration. In this way, the current operating state of the multi-zone device is reflected in the user interface.

As also illustrated in the block diagram of example multi-zone device 200, the multi-zone device can include a user interface management logic 503. The user interface management logic can include one or more hardware and/or software modules configured to manage the user interface. For example, the user interface management logic can include user interface driver modules (e.g., a display driver module, LED driver module, etc.) that causes the user interface to provide the visual indications. In some instances, the user interface management logic is configured to receive data corresponding to the playback zone configuration, and to update the user interface based on the data. For example, the user interface management logic can convert the playback zone information into corresponding commands to cause the user interface to provide the visual indications corresponding to the playback zone configuration. In some instances, the playback zone management logic is configured to cause the user interface management logic to update the user interface, for example by updating the appearance of the one or more regions in the set of regions.

As illustrated in the block diagram of the example multi-zone device 200, the multi-zone device can also include an output management logic 504. The output management logic 504 can include one or more hardware and/or software modules configured to manage the set of outputs 201. For example, the output management logic 504 can include one or more hardware or software modules to process, route, mix, code, decode, amplify, etc., content to be provided via the set of outputs 201. As another example, the output management logic 504 can be configured to receive playback zone information from playback zone management logic 502 and configure the outputs accordingly. For example, the output management logic 504 can instantiate one or more software modules to form a virtual playback entity corresponding to a zone, and associate any particular outputs to the playback entity for playback and control of the zone.

As described before and also illustrated in the block diagram of example multi-zone device 200, the multi-zone device can include a user interface 202 comprising a set of regions. In some instances, the user interface comprises a graphical user interface, and the set of regions can be regions of the graphical user interface. For example, in some instances, the user interface can comprise a display, and the set of regions can be regions of the display. In these cases, the visual indications can be graphical visual indications (e.g., icons, images, video, shapes, colors, text, etc.) displayed via the display. As another example, in some instances, the user interface can comprise a set of LEDs, and each region in the set of regions can comprise at least one LED in the set of LEDs. In these cases, the visual indications can comprise the lights of the LEDs (e.g., a light on can be considered a visual indication, or a light of a particular color, or a light flashing with a certain pattern, etc.). As another example, in some instances, the user interface can comprise an LED strip, and the set of regions can comprise regions of the LED strip. In these cases, the visual indications could similarly be related to the lights emitted by the LEDs. Other examples are possible.

Updating the user interface in block 302 of method 300 can involve causing the user interface to provide the one or more visual indications. For example, if the user interface comprises a display, updating the user interface can involve causing the display to display the one or more visual indications. Similarly, if the user interface comprises a set of LEDs or an LED strip, updating the user interface can involve updating the status of the LEDSs such as by causing one or more of the LEDs or portions of the LED strip to turn on/off, to turn a particular color or pattern, etc.

In some instances, the user interface can be configured to receive inputs from a user. For example, the user interface can include one or more buttons, touch surfaces or selectable indications that, when selected, cause the multi-zone device to perform actions. In some instances, the user can interact with the user interface to obtain more information about the zone's configuration. For example, the user interface can comprise a touch surface such as a touch display. The touch display can be the same or part of the same display where the visual indications are displayed. The user can then select a particular visual indication to obtain more information. Selecting a visual indication could, for example, cause the user interface to provide more information about the selected zone, such as a zone name, status of devices, volume, content currently being played back, etc. In some instances, the user interface can additionally provide options to control aspects of the one or more zones hosted by the multi-zone device. For example, selecting a particular visual indication corresponding to a zone could cause the multi-zone device to update the user interface to show options to control the particular zone (e.g., playback options to stop and start playback, volume control, etc.). In some instances, the user interface comprises an interface responsive to particular user gestures such as touches, double touches, holds, scrolls, drags, drops, etc. Each of those gestures can be configured to cause the multi-zone device to perform a particular action. For example, the user interface could comprise a slider touch interface. The slider touch interface could be the user interface 202 itself, or any other interface (for example, a physical slider interface physically parallel to the user interface 202). Certain user gestures could then be used to expand audio or other content from one zone into one or more other zones of the multi-zone device. For example, a two-finger touch across two zones (e.g., one finger on each zones's visual indication or other corresponding part of the user interface) could cause the multi-zone device to synchronize content across the two zones (e.g., to “copy” or expand audio from one active zone to another idle zone). As another example, a “swipe” from an active zone to a set of inactive zones could cause the audio to be “swapped” or transferred to those other neighboring zones with ease. In this way, the user interface could follow the actions of the user touch to indicate the desired configuration was received.

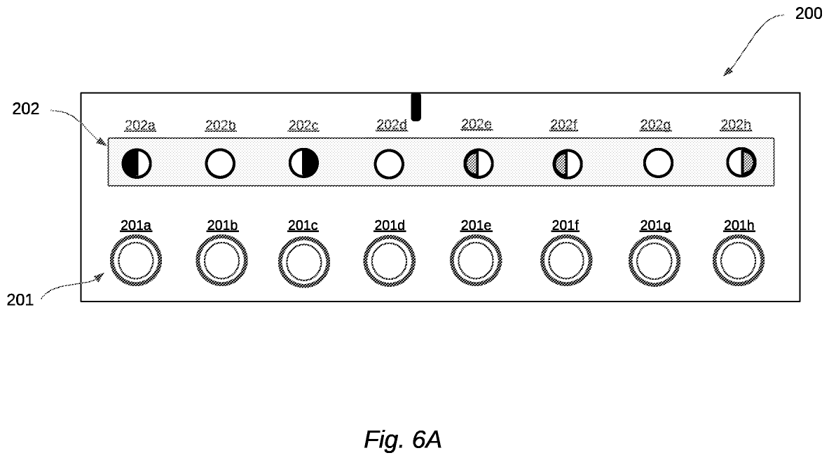

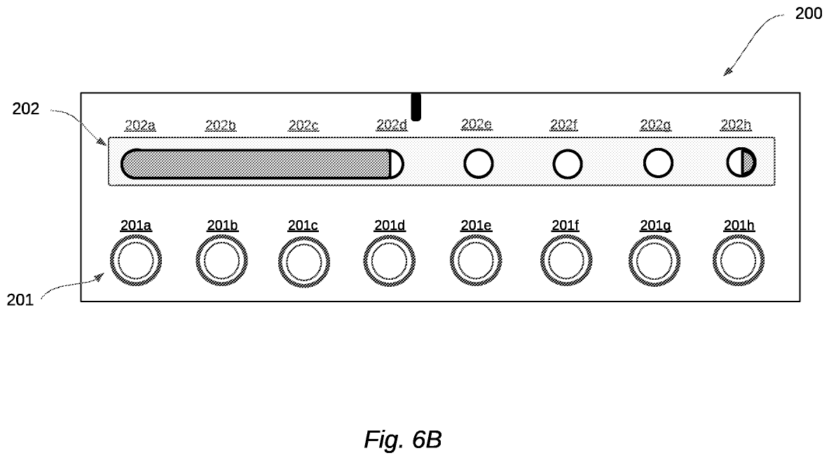

Turning to FIG. 6A, another example of an instance of user interface 202 of multi-zone device 200 is illustrated. Some of the examples provided before in this disclosure involve playback zones that are associated with single or consecutive outputs of the multi-zone device. However, in some scenarios, there can be playback zones that are associated with non-consecutive outputs. As shown in FIG. 6A, the multi-zone device 200 can be configured to implement a playback zone associated with the first output 201a and the third output 201c. As illustrated, visual indications in the corresponding regions 202a and 202c can be provided in a way so as to indicate that the zone is not complete and/or that the particular output is associated with a zone that involves other outputs. For example, the visual indications can be provided partially, so as to indicate that the rest of the zone might be indicated somewhere else. In a similar example, the multi-zone device can be configured to implement a playback zone associated with outputs 201e, 201f, and 201 h. As illustrated, visual indications can be provided in the corresponding regions 202e, 202f and 202h to indicate that the zone is not complete and/or that the particular output is associated with a zone that involves other outputs. As illustrated, these visual indications have at least one characteristic (e.g., color, shape, etc.) in common so as to indicate that they relate to the same zone. At the same time, they are different from the other indications corresponding to other zones (e.g., a different color, shape, etc.). In a similar example, FIG. 6B illustrates the multi-zone device 200 configured to implement a first playback zone associated with the first set of outputs 201a, 201b, 201c, 201d and the last output 201h. As illustrated, visual indications in first set of regions 202a, 202b, 202c, 202d can be provided in a way so as to indicate that the zone is not complete and/or that the particular output is associated with a zone that involves other outputs. In the example of FIG. 6B, the visual indication in region 202d is visually different (e.g., a partial visual indication) so as to indicate that the zone comprises another non-consecutive output. The visual indication in region 202h can likewise be visually different so as to indicate it corresponds to the same zone. As illustrated, the visual indications can have a characteristic in common such as a same color so as to indicate that they correspond to a same zone. Additionally, visual indications of non-consecutive outputs (such as the visual indications in regions 202d and 202h) can have a visual characteristic that indicates that they belong to the same zone (e.g., same color or characteristic as all other members of the zone) and additionally a visual characteristic that indicates that the zone is not complete and that the output is in a zone with another non-consecutive output. As such, a visual indication of a zone can comprise one or more parts distributed across different (and separate) regions of the user interface. The different parts can complement each other in various way to indicate that they form a same zone (e.g., geometrically complement each other, or have a same color, pattern, etc.).

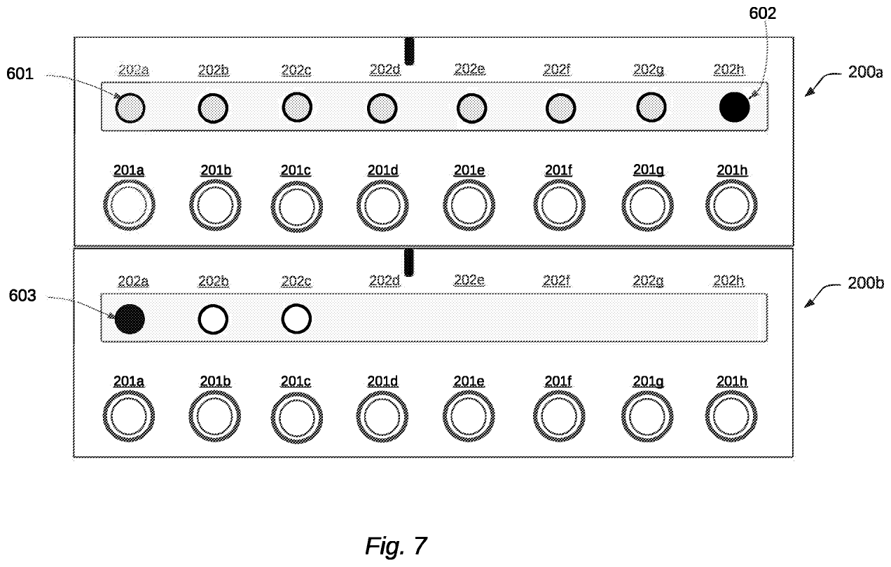

Turning to FIG. 7, another example of an instance of user interface 202 of multi-zone device 200 is illustrated. In some instances, more than one multi-zone device can be used at the same time, and certain zones can be associated with outputs of more than one multi-zone device. For example, a zone of a media playback system can be associated with at least one output of a first multi-zone device and at least one output of a second multi-zone device. In these cases, the visual indications provided in the different multi-zone devices can have a common characteristic so as to indicate that they correspond to the same zone. FIG. 7 illustrates an example of this scenario. In the example of FIG. 7, the first multi-zone device 200a can be configured to implement a first zone associated with 7 outputs (e.g., a home theater zone), and another zone associated with the remaining output 202h. This last zone can also be associated with another output of another multi-zone device 200b. As illustrated, the visual indications 602 and 603 provided in the corresponding regions of the different multi-zone devices can have at least one characteristic in common to indicate that they relate to the same zone.

In some instances, the multi-zone device can include two or more mirrored user interfaces so that the information in the user interface can be seen from different positions. For example the multi-zone device can include a user interface in the back of the device for an installer, and another user interface in the front for the end user. These user interfaces can be the same or different. Furthermore, the multi-zone device can include additional user interfaces and/or additional regions or options on the user interfaces to enable a user to interact with the device. The multi-zone device can also include other types of inputs and outputs.

### IV. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A multi-zone device comprising:
one or more network interfaces;
a set of audio outputs comprising at least a first audio output and a second audio output;
a user interface comprising a set of regions, the set of regions comprising at least a first region corresponding to the first audio output and a second region corresponding to the second audio output;
at least one processor; and
at least one non-transitory computer-readable medium comprising program instructions that are executable by the at least one processor such that the multi-zone device is configured to:
receive, via the one or more network interfaces, data corresponding to a playback zone configuration indicating one or more playback zones to be implemented via the multi-zone playback device, wherein each playback zone is associated with respective one or more audio outputs in the set of audio outputs; and
based on the data corresponding to the playback zone configuration, update, with one or more visual indications, the appearance of one or more regions in the set of regions, the one or more regions corresponding to the respective one or more audio outputs associated with the one or more playback zones, so that the user interface reflects the playback zone configuration;
wherein:
when the data corresponding to the playback zone configuration indicates one or more of: (i) a first playback zone associated with the first audio output or (ii) a second playback zone associated with the second audio output: updating the appearance of the one or more regions comprises one or more of: (i) updating, with a first visual indication, the appearance of the first region corresponding to the first audio output; or (ii) updating, with a second visual indication, the appearance of the second region corresponding to the second audio output; wherein the first visual indication is different from the second visual indication; and
when the data corresponding to the playback zone configuration indicates a playback zone associated with both the first audio output and the second audio output: updating the appearance of the one or more regions comprises updating, with a third visual indication, the appearance of both the first region corresponding to the first audio output and the second region corresponding to the second audio output, wherein the third visual indication is the same for both the first region and the second region.

2. The multi-zone device of claim 1, wherein:
the first visual indication extends over at least a portion of the first region without extending to the second region;
the second visual indication extends over at least a portion of the second region without extending to the first region; and
the third visual indication continuously extends over at least a portion of both the first region and the second region.

3. The multi-zone device of claim 1, wherein the third visual indication comprises a first part of the third visual indication in the first region and a second part of the third visual indication in the second region.

4. The multi-zone device of claim 3, wherein the first part is separate from the second part.

5. The multi-zone device of claim 4, wherein the first part and the second part have at least one characteristic in common.

6. The multi-zone device of claim 5, wherein the at least one characteristic comprises a color.

7. The multi-zone device of claim 5, wherein the at least one characteristic comprises a pulsing pattern.

8. The multi-zone device of claim 5, wherein the at least one characteristic comprises a text descriptor.

9. The multi-zone device of claim 5, wherein the at least one characteristic comprises an animation.

10. The multi-zone device of claim 1, wherein the first visual indication is different from the second visual indication at least in that the first visual indication is separate from the second visual indication.

11. The multi-zone device of claim 1, wherein the first visual indication is different from the second visual indication in at least one characteristic.

12. The multi-zone device of claim 1, wherein:
the set of regions are distributed along a linear surface; and
updating the appearance of the one or more regions comprises updating, with the one or more visual indications, portions of the linear surface corresponding to the one or more regions.

13. The multi-zone device of claim 12, wherein updating the portions of the linear surface with the one or more visual indications comprises updating the portions of the linear surface with one or more of a light, a color, a graphical indication, or a text descriptor.

14. The multi-zone device of claim 1, wherein the one or more visual indications comprise one or more of a light, a color, a graphical indication, a text descriptor, or a shape.

15. The multi-zone device of claim 1, wherein:
the user interface comprises a graphical user interface; and
the set of regions comprises regions of the graphical user interface.

16. The multi-zone device of claim 1, wherein:
the user interface comprises a display; and
the set of regions comprises regions of the display.

17. The multi-zone device of claim 1, wherein:
the user interface comprises a set of LEDs; and
each region in the set of regions comprises at least one LED in the set of LEDs.

18. The multi-zone device of claim 1, wherein:
the user interface comprises an LED strip; and
the set of regions comprises regions of the LED strip.

19. The multi-zone device of claim 1, further comprising:
a playback zone management logic, and
a user interface management logic.

20. The multi-zone device of claim 19, wherein the playback zone management logic is configured to:
process the playback zone configuration information to implement the one or more playback zones; and
cause the user interface management logic to update the appearance of the one or more regions in the set of regions.
